(19) United States
(12) Patent Application Publication
(10) Pub. No.: US 2010/0244444 A1
(43) Pub. Date: Sep. 30, 2010

(54) COMMUNAL HEATING AND POWER STATION UNIT HAVING A RECIPROCATING INTERNAL COMBUSTION ENGINE AND HAVING AN ELECTRICAL MACHINE

(76) Inventor: Christian Appel, Rellingen (DE)

Correspondence Address: WHITE & CASE LLP;PATENT DEPARTMENT, 1155 AVENUE OF THE AMERICAS, NEW YORK, NY, 10036, US

(21) Appl. No.: 12/718,036

(22) Filed: Mar. 5, 2010

(30) Foreign Application Priority Data
Mar. 6, 2009 (DE) 102009011477.7-13

(51) Int. Cl. H02K 7/18; F01P 1/06; F02N 11/04

(52) U.S. Cl. 290/2; 123/41.31; 290/46

(57) ABSTRACT

According to the invention, a communal heating and power station unit having a reciprocating internal combustion engine and having an electrical generator, which are coupled to one another by means of a shaft which transmits power, with the generator having a stator and a rotor, with the rotor being borne in a floating manner and with a reciprocating internal combustion engine housing also forming the stator housing or the stator housing being flange-connected to the reciprocating internal combustion engine housing.

The invention relates to the use of a reciprocating internal combustion engine and of an electrical machine, preferably an electrical generator, which are coupled to one another by means of a shaft which transmits power, with the generator having a stator and a rotor, and to a communal heating and power station unit having an engine such as this and having a machine such as this.

### PRIOR ART

Units for communal heating and power stations of the type mentioned initially are known from the prior art, in which a reciprocating internal combustion engine and an electrical generator are borne on a separate appliance mount. This appliance mount is normally a steel frame, which has to satisfy stringent requirements relating to the manufacturing accuracy of the bearing sets for the reciprocating internal combustion engine and the electrical generator, and relating to the stiffness, in particular twisting stiffness. This is because the relative installation position of the reciprocating internal combustion engine with respect to the generator is of critical importance. Both the reciprocating internal combustion engine and the generator each have a shaft. In practice, these two shafts are coupled to one another by a coupling. Any possible offset in the alignment between the two shafts leads to undesirable bending moments in the bearings of the reciprocating internal combustion engine and/or of the generator. Furthermore, even if the reciprocating internal combustion engine, the coupling, the generator and the appliance mount are manufactured precisely, it is frequently not possible to ensure that the alignment is also ensured at different operating temperatures. In order to counter the risk of the offset in the alignment of the shafts, the appliance mount in particular, but also the reciprocating internal combustion engine, the coupling and the generator, are designed to be sufficiently physically strong and stiff that it is also possible to comply with the frequently strict tolerance limits for the alignment accuracy during operation.

Conventional communal heating and power stations which are intended for use in relatively large heat sinks furthermore have internal combustion engine/generator connections or generator variants in which, in particular, maintenance requirements are a primary factor, and therefore the size and the weight of a communal heating and power station such as this are of secondary importance.

The units for communal heating and power stations that are known from the prior art have a serious disadvantage, however, in particular because the stringent requirements relating to manufacturing accuracy mean that a unit such as this is heavy and has relatively large dimensions.

### OBJECT

The invention is therefore based on the object of specifying a communal heating and power station unit having the features described initially, whose spatial dimensions are, however, as small and compact as possible, and which has a weight which is as low as possible.

### DESCRIPTION

The object is achieved by a communal heating and power station unit according to the invention having an internal combustion engine and having an electrical generator, which are coupled to one another by means of a shaft which transmits power, the generator having a stator and a rotor, in that the rotor is borne in a floating manner and a reciprocating internal combustion engine housing also forms the stator housing and/or the stator, or the stator housing and/or the stator is flange-connected to the reciprocating internal combustion engine housing, or else in that an engine and generator such as these are used as a communal heating and power station unit.

The expression a communal heating and power station unit should be understood to be a unit for a communal heating and power station. A unit such as this may have all the components required for this purpose which are necessary in order to also operate the unit independently of an electrical power supply system. In particular, the components also include a reciprocating internal combustion engine. A reciprocating internal combustion engine such as this may, for example, be a four-stroke gasoline engine, a diesel engine, a Stirling engine or some other reciprocating internal combustion engine which is designed to burn a fuel and air mixture in a combustion chamber, and to drive a piston.

Furthermore, the communal heating and power station unit according to the invention has an electrical generator with a stator and a rotor. A generator of this type may, for example, be an electrical asynchronous generator or synchronous generator. The stator and/or the rotor of the generator preferably have/has coils which, in particular, are arranged with respect to one another in such a manner that AC voltages which are offset in time are produced at the outputs of the stator. In particular, these may be three AC voltages whose phase angles are respectively shifted through 120 degrees.

Other arrangements of the electromagnetic components of the generator are also possible. For example, the electrical generator may be designed in such a way that the generator, for example, also has more than the three AC voltages, in particular a multiple of the three AC voltages, that is to say for example 6, 9 or 12 AC voltages, at the outputs of the generator. The output voltages of the generator can preferably be transformed by a conversion apparatus to three AC voltages, which are respectively offset through 120°, or to one voltage at an essentially constant potential, in particular a DC voltage.

According to the invention, the reciprocating internal combustion engine and the electrical generator are coupled to one another by means of a shaft which transmits power. It is known from the prior art that a coupling such as this may be in the form of a clutch. A clutch such as this may, for example, be a disk clutch or some other clutch which is provided with damping elements and/or with elements to compensate for any alignment inaccuracy. Furthermore, the coupling may in particular also be provided by a gearbox. In comparison to refinements from the prior art such as this, it is preferable for one particular refinement according to the invention for the shaft which transmits power to form both the crankshaft of the reciprocating internal combustion engine and the shaft of the generator and/or of the rotor. It is therefore preferable for the shaft not to be interrupted by disconnecting elements. In particular, the crankshaft may comprise individual elements which are connected by means of interference fits. Furthermore, the crankshaft of the internal combustion engine may also be fixedly connected to the shaft of the generator and/or of the rotor, in particular by pressing them firmly to one another. The crankshaft of the reciprocating internal combustion engine can therefore be connected to the shaft of the generator and/or of the rotor by a fit, in particular an interference fit.

The invention also covers the rotor being borne in a floating manner. A floating bearing is distinguished in that it is formed only on one side of the object to be borne. It is therefore preferable for the rotor to be borne only on its side facing the internal combustion engine. In other words, the rotor is preferably borne on only one side. In one particularly preferred embodiment, the rotor is borne on one side and/or in a floating manner by a bearing of the crankshaft of the internal combustion engine, in which case the bearing may have a plurality of bearing points. For this purpose, the crankshaft may be borne on the internal combustion engine housing in which case some of the plurality of bearing points, in particular, may be formed by the housing, or the bearing points may be firmly connected to the housing. Furthermore, the crankshaft bearing may comprise a plurality of bearings. These bearings are preferably radial bearings or journal bearings. Furthermore, individual bearings or all of the bearings in the bearing system may also have, in particular, a limited degree of freedom in the axial direction of the crankshaft in addition to the degree of freedom about the rotation axis of the crankshaft, as a result of which the shaft is preferably not borne hyperstatically.

It is particularly preferable for that bearing which is positioned closest to the rotor to be a radiax bearing, which means that it can absorb not only radial but also axial forces. In one preferred refinement variant, the crankshaft bearing, which preferably has a plurality of bearing points, is also the only bearing of the rotor. For this purpose, the rotor preferably has no bearing on the side remote from the internal combustion engine. On this remote side, the stator and/or the generator can essentially be sealed by an end wall, or can be sealed except for an aperture for the rotor shaft, with the shaft preferably being sealed, in particular in an air-tight and/or dirt-tight manner, by the end wall, by means of a sealing ring. A sealing ring that has been cited for this refinement variant essentially absorbs no forces and/or moments.

In one particularly preferred refinement variant of the communal heating and power station unit, the rotor is attached, in particular in a rotationally fixed manner, to a first, floating shaft end, which projects outward from a first end face of the reciprocating internal combustion engine housing. The expression end faces of an internal combustion engine housing means those outer faces of the internal combustion engine where a shaft which transmits power, in particular a crankshaft, emerges. A reciprocating internal combustion engine normally has a crankshaft which emerges on two opposite faces of the reciprocating internal combustion engine housing, specifically on a first and a second end face. If the crankshaft emerges on only one face of a reciprocating internal combustion engine, then this reciprocating internal combustion engine also has only one (such) first end face. It is preferable for a floating shaft end, which projects outward from the first end face, in particular the floating crankshaft end which projects outward, to be connected to the rotor shaft or to the rotor. In other words, it is preferable for the rotor to be connected to the crankshaft directly and preferably without any step-up ratio and without a clutch, or to be attached to it in a rotationally fixed manner. Furthermore, it is preferable for the rotor to be arranged coaxially with respect to the first floating shaft end or with respect to the rotation axis of the shaft.

Furthermore, according to one alternative (I), it is according to the invention for a reciprocating internal combustion engine housing also to form a housing of the stator (stator housing) or, according to an alternative (II), it is according to the invention for the stator housing to be flange-connected to the internal combustion engine housing. As is also evident from the previous sentence, (I) and (II) relate to alternative aspects of the present invention.

According to alternative (I), a stator housing is preferred which is formed by the internal combustion engine housing. The reciprocating internal combustion engine housing and the stator housing may therefore be one element. In one particularly advantageous refinement, they may be a single cast element. It is also possible for the reciprocating internal combustion engine housing and the stator housing to be connected to one another by an integral connection, in particular by a welded joint.

According to alternative (II), it is according to the invention for the stator to be flange-connected to the internal combustion engine housing. In order to achieve a high relative positioning accuracy, the stator and/or the stator housing may be attached to the internal combustion engine housing by a force-fitting and/or interlocking connection. Dowel pins are then preferably used to position the stator and/or stator housing with respect to the internal combustion engine housing.

According to alternative (II), it is particularly preferable for the flange elements of the stator or of the stator housing to be oriented radially outward, in order to allow the stator housing to be flange-connected to the reciprocating internal combustion engine housing in an advantageous manner. In order to ensure that the stator is also as compact as possible, or has as short an axial length as possible, the flange elements which are oriented outward can be configured in such a manner that they are essentially also connected only on the outside to the rest of the stator, and do not increase its axial length. The flange elements therefore do not change the axial length of the generator, but possibly only its maximum external diameter in the area of the flange elements. The flange elements of the stator are preferably formed coaxially with respect to the rotation axis of the rotor, such that, in particular, the flange forms a circumferential, sealing surface between the stator, or the stator housing, and the internal combustion engine housing.

In a further preferred embodiment variant according to alternative (II), the flange elements of the stator have a radial and axial orientation outward such that the flange elements grip the reciprocating internal combustion engine housing from the outside, and are preferably flange-connected to its side wall.

None of the following embodiments, aspects and/or features of the invention are restricted to one of the alternatives. In fact, in principle, they apply to both alternatives.

For a further preferred refinement of the communal heating and power station unit, the wall of a first end face of the reciprocating internal combustion engine housing also forms an end wall of the stator. The expression end faces of the stator means those outer faces of the stator on which a shaft which transmits power emerges. For the stator, the shaft which transmits power may be the shaft of the rotor (rotor shaft). One embodiment variant of the communal heating and power station unit is therefore also characterized in that a separating wall is formed between the reciprocating internal combustion engine housing and the stator housing, by the wall of one end face of the internal combustion engine housing and, in particular because the stator does not have its own end wall, also forms an end wall of the stator oriented with respect to the internal combustion engine. This embodiment variant has the advantage that, although the stator in theory has an outer face, specifically that which is oriented with respect to the internal combustion engine, the end wall of the generator is, however, not formed on this outer face by the stator but by the end face of the reciprocating internal combustion engine. The outer face of the stator which is oriented away from the reciprocating internal combustion engine can be closed by an end wall, or else may have an aperture for the rotor shaft.

In one particularly simple embodiment variant, the stator housing has a body structure which is designed in such a manner that further stator components can be attached to it. The stator housing can therefore be a mount for the electromagnetically acting elements of the stator. One such element may be a stator crown. The stator crown surrounds the common, preferably ferro-magnetic, core, in particular an iron core, for the coils of the stator. The stator crown is preferably an essentially cylindrical element with teeth which project inward, distributed regularly over the circumference. If the electrical machine has an external rotor, the teeth may alternatively also project outward. The teeth of the stator crown are designed in the conventional manner such that coil windings can be passed around them. The stator crown is furthermore preferably a laminated core, which is composed of a large number of laminates, or a laminated core wound in particular from one laminate. Furthermore, the stator crown and the stator housing may be connected in such a way that this connection forms an interference fit, thus resulting in a very small manufacturing tolerance.

Communal heating and power stations are also distinguished in particular by electrical and thermal power being transmitted to loads. The coupling of a reciprocating internal combustion engine to an electrical generator allows mechanical power to be transformed to electrical power. However, this transmission is in principle lossy. These losses result essentially from the waste heat from the generator. In order to advantageously include the waste heat from the generator, which essentially also represents thermal energy, in the power or energy balance of a communal heating and power station, one advantageous refinement of the communal heating and power station unit according to the invention is distinguished in that a cooling circuit in particular at the same time cools the reciprocating internal combustion engine and the stator, with a fluid or in particular water, oil or air preferably flowing through the cooling circuit. Furthermore, the cooling may have a heat pump, such that the thermal energy of the reciprocating internal combustion engine and/or of the stator or of the generator can be transmitted to an external load. This refinement advantageously makes it possible to increase the efficiency of the communal heating and power station unit by making use not only of the thermal power or energy of the reciprocating internal combustion engine but in the same way also the thermal power or energy of the electrical generator.

One particular embodiment variant of the unit is characterized in that at least one cooling line of the cooling is arranged on the radially outer circumference of the stator. This arrangement is also advantageous with regard to thermodynamic aspects. Because a thermodynamic system boundary is drawn between cooling and the rest of the stator, the majority of the thermal power or energy from the generator can be transmitted to the cooling. At best, the junction between the generator and the reciprocating internal combustion engine represents a subsystem boundary at which it would not be possible to transmit thermal power or energy directly to the cooling. However, this partial boundary is considerably smaller than the rest of the boundary, simply because of the ratio between the areas, as a result of which, during operation of the unit, the majority of the thermal power or energy of the generator can be transmitted to the cooling. The thermal power which is transmitted at the subsystem boundary can furthermore at least partially also be transmitted to the cooling of the reciprocating internal combustion engine, thus further improving the efficiency of the unit.

However, in addition to the efficiency, it may also be highly desirable for the unit to require as little maintenance as possible. One particularly advantageous variant of the unit is therefore distinguished in particular by the electrical machine being air-cooled. In contrast to the situation, for example, with water cooling, the electrical machine need not be provided with the coolant. In fact, the surrounding air can be used for cooling or, if the cooling is a closed system, the air which is present in the system. The stator and/or the rotor may have cooling ribs for this purpose. Air flowing past the ribs can absorb the heat energy from the ribs, or from the stator and/or the rotor, thus allowing cooling for the electrical machine.

Depending on the embodiment variant, the cooling ribs may be arranged differently. Particularly for an electrical machine with an internal rotor, the cooling ribs on the stator may project radially outward. The cooling ribs preferably extend over the longitudinal axis of the stator. However, the cooling ribs may also be in the form of webs, in particular radial webs, between two preferably cylindrical envelope surfaces. For this purpose, the envelope surfaces are advantageously arranged coaxially with respect to the rotation axis of the rotor. The webs and the envelope surfaces may furthermore form channels, in particular channels which are closed except for inlets and outlets. In order to produce an air flow for cooling, the electrical machine may have a fan wheel, which is preferably coupled to the shaft which transmits power, and/or is attached to the shaft in a rotationally fixed manner.

For an electrical machine in particular with an external rotor, the stator may have at least one channel, which in particular passes through it. A channel can particularly preferably be a bore which is formed coaxially with respect to the rotation axis of the rotor. Cooling ribs can advantageous project radially inward from the envelope surface of this channel. Furthermore, a shaft can pass through the channel. If this is the case, the cooling ribs in particular project only to such an extent that they do not touch the shaft. In particular, the radial distance between the outermost circumference of the shaft and that end of a rib which projects furthest may in particular be 0.1 mm to 5 mm, preferably 1 mm.

Furthermore, in order to comply with the requirements for a compact communal heating and power station unit, it is also advantageous for the generator to be compact. In order to design the unit advantageous from this point of view, the generator rotor is short. For this purpose, in particular, the rotor has a maximum length of 15, 12.5, 10, 7.5, 5, 4 or 3 cm. It is also advantageous for the ratio of the maximum radial diameter to the maximum length of the rotor to be greater than 4, in particular in a range from 4 to 10, preferably in a range from 5 to 8. A rotor configuration with the abovementioned ratio or a ratio from the abovementioned ranges makes it possible to achieve an advantageous compact generator form.

An alternative or further scale for compactness is the power density. By way of example, this can be calculated from the power which can be emitted with respect to the space occupied by the unit. In the sense of this requirement, a further advantageous refinement of the unit is characterized in that the rotor is separated by a narrow gap, in particular an air gap, in particular of a maximum of 2 cm, and preferably of a maximum of 5 mm, from the first end face of the reciprocating internal combustion engine housing. This advantage is reinforced in a preferred manner if the reciprocating internal combustion engine housing also forms the separating wall from the stator housing. This is because the stator, in the wider sense, then does not have its own end wall, but shares this with the reciprocating internal combustion engine. Since the rotor is positioned as close as possible to the end face of the reciprocating internal combustion engine housing, the power density is increased because although a narrow air gap does not contribute to increasing the power which can be emitted, the volume occupying the unit is, however, reduced, as a result of which the power density is increased and the unit is compact or becomes more compact.

Arranging the rotor as close as possible to the above-mentioned end wall therefore increases the power density of the unit. A further advantage of this short distance is a reduced moment, in particular bending or tilting moment, which acts through the rotor on the bearing, in particular the internal combustion engine bearing. The bearing can therefore also be designed for lighter loads, which additionally makes it possible to reduce the weight of the unit, and possibly also the volume and/or the dimensions, thus additionally making it possible to increase the power density.

For a further refinement, which likewise advantageously improves the compactness of the unit, it is preferable to also be able to operate the generator as a motor. The generator can therefore also be an electrical machine. It is also preferable for the generator to be used in the motor mode in order to start the reciprocating internal combustion engine. Conventionally, reciprocating internal combustion engines have a starter which starts the reciprocating internal combustion engine from rest via a drive which can be decoupled, that is to say it causes the crankshaft to rotate. As soon as the starting power which the starter supplies to the reciprocating internal combustion engine is sufficient, the latter continues to run on its own. The starter is then mechanically decoupled from the reciprocating internal combustion engine. However, this also means that the starter is not used during normal operation of the reciprocating internal combustion engine. However, irrespective of the operating state of the starter, it occupies space (some space) in the unit. The preferred integration of the starter in the generator removes the need for a separate starter, thus making it possible to improve the compactness of the unit.

Conventional industrial engines in general have an inertia element which is connected to the crankshaft. From the aspect of improving the compactness of the unit as well, it is preferable for the reciprocating internal combustion engine and/or the generator not to have a separate inertia element, in particular not to have a flywheel. At most, it may be preferable for the rotor to be an inertia element of the reciprocating internal combustion engine. Even if the rotor is an inertia element, it is also particularly preferable for no separate inertia element, in particular no flywheel, to be attached to the crankshaft in the generator-side area leading away from the reciprocating internal combustion engine. Should it nevertheless be advantageous for the reciprocating internal combustion engine to have an inertia element, an inertia element, in particular a separate inertia element and preferably a flywheel, can be attached to the crankshaft in the area which is remote from the generator side and leads away from the reciprocating internal combustion engine.

Furthermore, the use according to the invention of the unit in a communal heating and power station is characterized in that the cooling is coupled to a heat dome, which transmits the thermal power, in particular the heat power from the reciprocating internal combustion engine and the generator or the stator to a thermodynamic system. By way of example, a thermodynamic system such as this may be a load or a heat pump, which transmits the thermal power preferably to some other power transmission system, in particular a heating circuit.

### REFERENCE SYMBOLS

| Reference | |
|---|---|
| symbol | Meaning |
| 2 | Reciprocating internal combustion engine |
| 4 | Crankshaft |
| 6 | Piston |
| 8 | Cylinder |
| 10 | Reciprocating internal combustion engine |
| | housing |
| 12 | Bearing point |
| 14 | First end face of the reciprocating |
| | internal combustion engine housing |
| 16 | Second end face of the reciprocating |
| | internal combustion engine housing |
| 20 | Electrical generator |
| 22 | Rotor |
| 24 | Stator |
| 26 | Rotor shaft |
| 28 | Stator coil |
| 30 | First end face of the stator housing or of |
| | the stator |
| 32 | Second end face of the stator housing or of |
| | the stator |
| 34 | Stator housing |
| 36 | First bearing point |
| 38 | Second bearing point |
| 40 | Communal heating and power station unit |
| 42 | Reciprocating internal combustion engine |
| 44 | Electrical generator |
| 46 | Crankshaft |
| 48 | Piston |
| 50 | Cylinder |
| 52 | Reciprocating internal combustion engine |
| | housing |
| 54 | Bearing point |
| 56 | First end face of the reciprocating |
| | internal combustion engine housing |
| 58 | Second end face of the reciprocating |
| | internal combustion engine housing |
| 60 | Rotor |
| 62 | Gap, in particular air gap |
| 64 | Maximum radial diameter of the rotor |
| 66 | Maximum axial length of the rotor |
| 68 | Rotor shaft |
| 70 | Stator housing |
| 72 | Stator |
| 74 | Flange element |
| 76 | Motor cooling line |
| 78 | Generator cooling line |
| 80 | Stator crown |
| 82 | Contact surface |
| 84 | Stator teeth |
| 86 | Rotor mount element |
| 88 | Permanent magnet |
| 90 | Stator coil |
| 92 | Pipe connecting line |
| 94 | Electrical connecting line |
| 96 | Flange element |
| 98 | Projecting shaft end |
| 100 | Conical area of the rotor mount element |
| 102 | Cover |
| A | Generator-side area leading away from the |
| | reciprocating internal combustion engine |
| B | Non-generator-side area leading away from |
| | the reciprocating internal combustion |
| | engine |

### EXEMPLARY EMBODIMENTS

Further advantageous developments, features and aspects of the invention will be explained in the description, with reference to the following exemplary embodiments. In the figures:

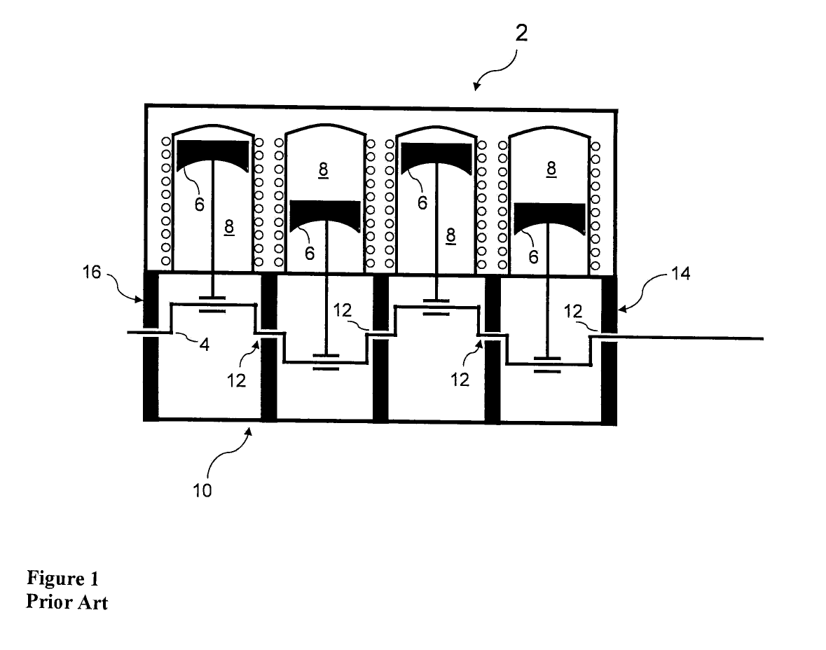

FIG. 1 shows a section illustration through a known reciprocating internal combustion engine,

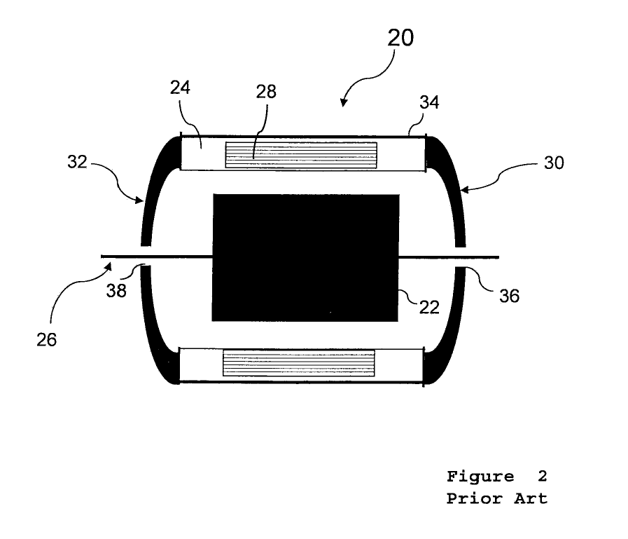

FIG. 2 shows a section illustration through a known electrical generator,

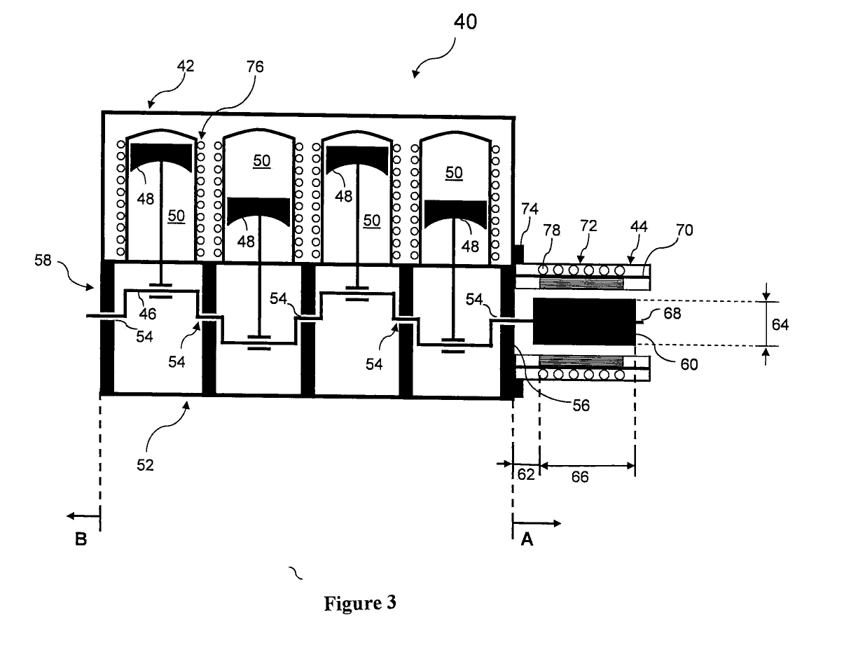

FIG. 3 shows a simplified section illustration through the communal heating and power station unit according to the invention, in particular according to alternative (I),

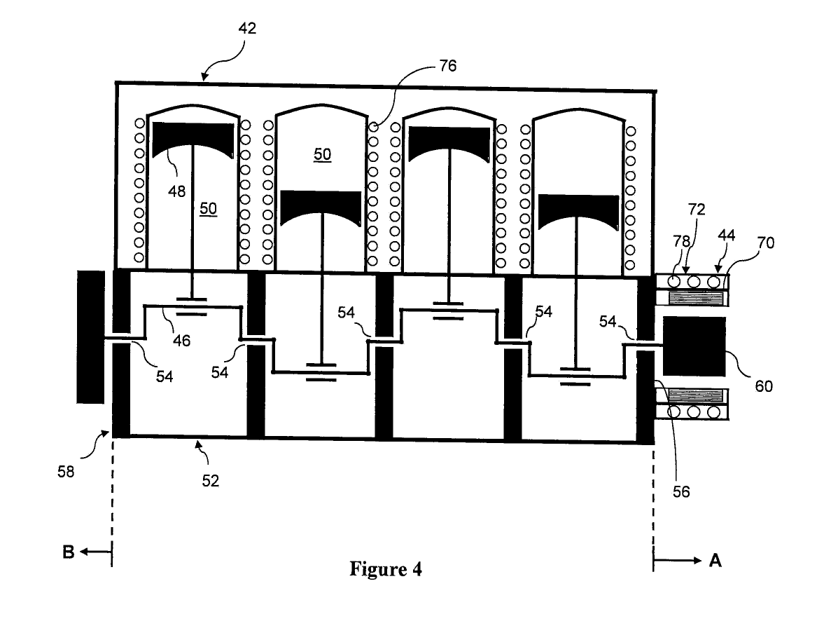

FIG. 4 shows a further simplified section illustration through the communal heating and power station unit according to the invention, in particular according to alternative (II),

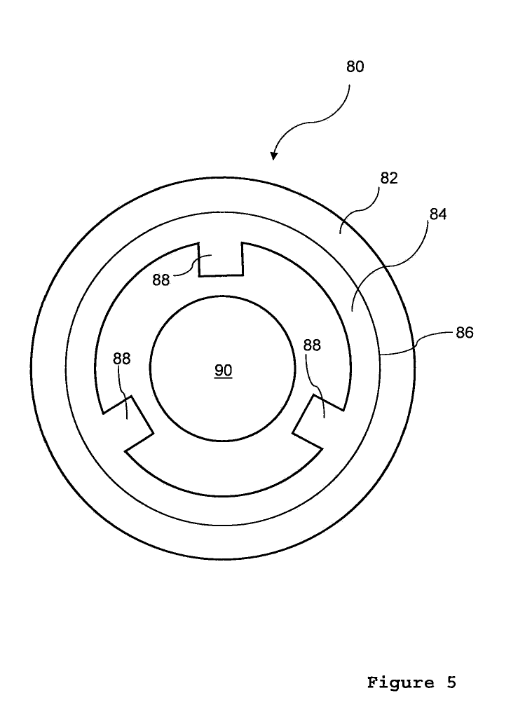

FIG. 5 shows a simplified cross-sectional illustration of the electrical generator, and

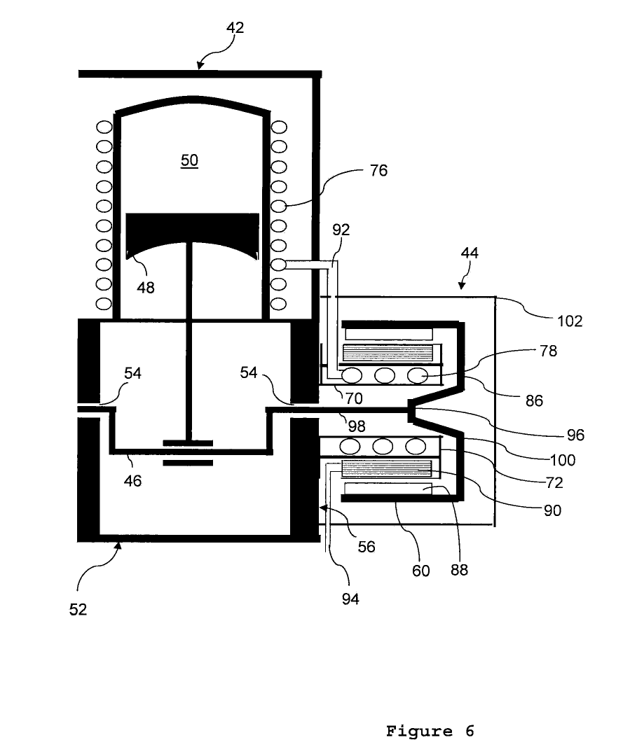

FIG. 6 shows a further, simplified section illustration through the communal heating and power station unit according to the invention with an external-rotor generator.

FIG. 1 shows a known reciprocating internal combustion engine 2. This reciprocating internal combustion engine has a crankshaft 4, four pistons 6, four cylinders 8 and a reciprocating internal combustion engine housing 10. The crankshaft 4 is borne at five bearing points 12. The crankshaft 4 emerges on a first end face 14 and a second end face 16 of the reciprocating internal combustion engine housing 10, at the outer bearing points 12 of the reciprocating internal combustion engine housing 10.

As is known, combustion in the combustion chamber of the cylinder 8 causes accelerated movement of the piston 6, which in turn causes the crankshaft 4 to rotate. The mechanical power of the reciprocating internal combustion engine, in particular characterized by a rotation speed and a torque of the crankshaft 4, can be transmitted through the crankshaft 4 to external systems.

FIG. 2 schematically illustrates a known electrical generator 20. It is known from the prior art that a generator 20 such as this can be coupled to the reciprocating internal combustion engine 2 via a clutch and/or a gearbox. The electrical generator 20 has a rotor 22 and a stator 24. Particularly during operation of the electrical generator 20, the rotor 22 and the stator 24 electromagnetically interact with one another. When the rotor is externally driven to rotate by the rotor shaft 26, then the rotor 22 induces an electrical voltage in the stator coils 28. Furthermore, the stator has a stator housing 34. The walls of the first end face 30 and of the second end face 32 of the stator 24 are surrounded by the stator housing, and/or are formed by it. The rotor 60 or the rotor shaft 26 is borne by the first bearing point 36 on the first end face 36 of the stator housing 34, and at a second bearing point 38 on the second end face 32 of the stator housing 34.

FIG. 3 shows a simplified schematic illustration of the communal heating and power station unit according to the invention. The communal heating and power station unit 40 has a reciprocating internal combustion engine 42 and an electrical generator 44. As is known from the prior art, the reciprocating internal combustion engine 42 has a crankshaft 46, four pistons 48, by way of example, and four cylinders 50 in a corresponding manner. Furthermore, the reciprocating internal combustion engine 42 has a reciprocating internal combustion engine housing 52 and, in particular, five bearing points 54, which bear the crankshaft 56 on the reciprocating internal combustion engine housing 52. The bearings in the bearing system are, in particular, characterized in that they do not transmit any significant torques to the reciprocating internal combustion engine housing 52 in the axial direction of the crankshaft 46. The bearings therefore have at least one degree of freedom.

The crankshaft emerges on the first end face 56, and in particular also on the second end face 58 of the reciprocating internal combustion engine housing, and/or projects beyond the reciprocating internal combustion engine housing. In particular, the crankshaft projects so far beyond the first end face 56 of the reciprocating internal combustion engine housing 52 that the rotor 60 and/or the rotor shaft of the electrical generator 44 are/is attached to the crankshaft in a rotationally fixed manner. The rotor 60 is therefore attached, in particular in a rotationally fixed manner, to a first flying shaft end, which projects outward from the first end face 56 of the reciprocating internal combustion engine housing 52. In other words, the rotor 60 is borne in a floating manner, or at one end. The rotor 60 is aligned coaxially with respect to the projecting shaft end of the crankshaft 46.

In order to ensure that the unit is as compact as possible, the rotor 60 is separated from the first end face 56 of the reciprocating internal combustion engine housing 52 by a narrow gap 62, in particular an air gap, in particular of a maximum of 2 cm, preferably of a maximum of 5 mm, preferably such that a moment which is as small as possible, in particular a bending or tilting moment, acts on the bearing points 54 through the rotor 60.

As can also be seen in FIG. 3, the reciprocating internal combustion engine 42 and the electrical generator 44 have a common shaft. The shaft forms both the crankshaft 54 of the reciprocating internal combustion engine 42 and the rotor shaft 68 of the electrical generator 44, or of the rotor 60. The rotor shaft 68 and the crankshaft 46 are therefore not separated by an additional component such as a clutch. And, in addition, only such that it is possible to separate the rotor 60 from the first end wall 56 of the reciprocating internal combustion engine housing 52 by the gap 62, which preferably has a width of only 5 to 20 mm. This advantage is, in particular, also enhanced by the stator housing 70 being flange-connected to the reciprocating internal combustion engine housing 52, in particular with the stator housing 70 being a subelement of the stator 72. The stator 72 is positioned with respect to the reciprocating internal combustion engine housing 52 by means of dowel pins, and in particular also by means of a force-fitting connection.

The flange elements 74 of the stator 72 and of the stator housing 70 are oriented radially outward. A connection between the reciprocating internal combustion engine 42 and the electrical generator 40 is therefore designed such that the connecting elements of the generator 44 cannot be intersected by an axis which is formed by two points, which are axially separated from one another and are located on the external circumference of the rotor, and the axis extends parallel to the rotation axis of the rotor. In other words, the flange elements are preferably designed such that a projection of the rotor cross-sectional area coaxially with respect to the rotor shaft axis onto the end face of the reciprocating internal combustion engine housing does not intersect the flange elements. In particular, the flange elements therefore do not point into the interior of the stator. Furthermore, the flange elements are designed with respect to the rest of the stator such that they do not influence, or do not lengthen, the axial length of the stator.

FIG. 4 shows an alternative refinement of the communal heating and power station unit.

In contrast to the illustration in FIG. 3, FIG. 4 shows that the reciprocating internal combustion engine housing 52 also forms the stator housing 70. The stator housing 70 and the reciprocating internal combustion engine housing 52 are therefore connected to one another without any interruption. They may be a common element, in particular a cast element. Furthermore, it is also possible for them to be welded to one another. In a further embodiment variant, the generator housing 70 and the reciprocating internal combustion engine housing are connected to one another with a force-fit and/or in an interlocking manner by means of a pressure binding or by an interference fit.

In addition, the illustration in FIG. 4 shows a short rotor and stator. This is because, it is preferable for a compact unit for the rotor and/or the stator to be short and, in particular, to have a maximum axial length 66 of 15, 12.5, 10, 7.5, 5, 4 or 3 cm. It is also preferable for the ratio of the maximum radial diameter 64 to the maximum axial length 66 of the rotor or of the stator to be greater than 4, in particular in a range from 4 to 10, and preferably in a range from 5 to 8.

As illustrated in FIG. 3 and in FIG. 4, it is advantageous for the wall of the first end face 56 of the reciprocating internal combustion engine housing 52 to also form an end wall of the stator 72. This is because, as the abovementioned illustrations have already shown, the unit is also characterized in particular by the stator not having its own end wall and by the stator housing 70 either being formed by the reciprocating internal combustion engine housing 52 or being flange-connected to it. There is therefore also no need for the stator 70 to have its own and/or a separate end wall. The end wall 56 of the reciprocating internal combustion engine housing is also the only separating wall in the boundary area between the generator and the reciprocating internal combustion engine.

Since the rotor 60 is borne at one end or in a floating manner, no bearing forces act on the stator through the rotor 60, as well. This is because the rotor bearing is also the bearing for the crankshaft 46 of the reciprocating internal combustion engine 42, which in particular has a number of bearing points 54.

Furthermore and in particular, FIG. 3 and FIG. 4 show a plurality of engine cooling lines 76 and generator cooling lines 78. The engine cooling lines are preferably arranged in the immediate vicinity of the cylinders 50. The generator cooling lines are arranged on the radially outer circumference of the stator. Both cooling lines preferably form turns around a cylinder and/or in the radially outer area of the stator. In one preferred refinement, the cooling lines can form a cooling circuit for cooling, which cools both the reciprocating internal combustion engine 42 and the generator 44, or the stator 72, with a fluid or in particular water, oil or air preferably flowing through the cooling circuit.

In one further preferred embodiment variant, the generator is brushless and/or can also be operated as a motor. If the generator can also be operated as a motor, then it can also be used in the motor mode to start the reciprocating internal combustion engine.

As is illustrated in FIG. 3, the communal heating and power station unit 40 does not have a separate inertia element, in particular no separate flywheel. This is particularly advantageous because no physical space is occupied by an inertia element, thus allowing the communal heating and power station unit to be very compact. In particular, no separate inertia element, in particular no flywheel, is attached to the shaft 46 or 68 in the generator-side area A leading away from the reciprocating internal combustion engine 42. At most, the rotor 60 may be in the form of an inertia element for the reciprocating internal combustion engine 42. If the reciprocating internal combustion engine 42 nevertheless requires a separate inertia element, then, as is also illustrated in FIG. 4, an inertia element, in particular a separate inertia element and preferably a flywheel, can alternatively or additionally be attached to the shaft 46 in the non-generator-side area B leading away from the reciprocating internal combustion engine.

FIG. 5 shows a highly simplified, schematic cross section through the electrical generator 44. The outer ring in FIG. 5 represents the stator housing 70, into which a stator crown 80 is inserted. The stator crown 80 and the stator housing 70 form a pressure binding, in particular an interference fit. The internal diameter of the stator housing 70 is therefore slightly smaller than the external diameter of the stator crown 80. It is particularly preferable for an inner envelope surface of the stator housing 70 and, in a corresponding manner, the outer envelope surface of the stator crown 80 to be cylindrical or conical, as a result of which a contact surface 82 between the stator crown 80 and the stator housing 70 is also essentially cylindrical or conical. Furthermore, the stator crown 80 and the stator housing 70 have guide elements in order to allow absolute positioning of the elements with respect to one another in the rotation direction about a longitudinal axis of the stator, in particular also during insertion of the stator crown 80. By way of example, an adjusting spring is also suitable for this purpose.

Furthermore, FIG. 5 shows three stator teeth 84 of the stator crown 80 which are oriented inward, in particular in the direction of the generator shaft 68. Depending on the design, a different number of teeth 84 can also be provided, and/or the teeth 84 may have a different shape. It is known from the prior art for the windings of the stator coils to be passed around these teeth 84. As an alternative to the arrangement with three teeth and with three coils, sixteen electro-magnetic coils are arranged in a preferred manner, distributed uniformly over the circumference of the stator.

The illustration in FIG. 6 shows a detail of a further preferred refinement of the communal heating and power station according to the invention. Corresponding to the illustrations in FIGS. 4 and 5, the communal heating and power station has a reciprocating internal combustion engine 42—only a detail of which is shown here, in a simplified form—and an electrical generator 44. In particular, the reciprocating internal combustion engine 42 has a crankshaft 46, pistons 48 and cylinders 50. Furthermore, the reciprocating internal combustion engine 42 has a reciprocating internal combustion engine housing 52 as well as bearing points 54, which bear the crankshaft 46 on the reciprocating internal combustion engine housing 52.

The crankshaft emerges on the first end face 56 and/or projects beyond the reciprocating internal combustion engine housing. In particular, the crankshaft projects so far on the first end face 56 of the reciprocating internal combustion engine housing 52 that a rotor mount element 86 of the rotor 60 is attached in a rotationally fixed manner to the crankshaft 46, in particular to its projecting shaft end 98. This is because the rotor mount element 86 results in the rotor 60 being coupled and/or connected to the crankshaft 46 in a rotationally fixed manner. The rotor mount element 86 is preferably flange-connected to the crankshaft 46 in a rotationally fixed manner. For this purpose, the rotor mount element 86 and the crankshaft 46 may have flange elements 96 which are designed to match one another and can be connected to one another in a force-fitting and/or interlocking manner, for example by means of screw connections and/or dowel pins. The rotor mount element 86 is therefore attached, in particular in a rotationally fixed manner, to a first flying shaft end which projects outward from the first end face 56 of the reciprocating internal combustion engine housing 52. In other words, the rotor mount element 86 and therefore the rotor 60, as well, are borne in a floating manner or at one end.

In particular by analogy with a car wheel rim, the rotor mount element 86 may also have spokes, with the spokes being in the form of a propeller blade or fan blade. In other words, the rotor mount element 86 may have webs which extend radially outward, are preferably in the form of a fan blade, and, particularly preferably, are arranged distributed over the circumference. In particular, the webs can carry out two tasks during operation of the electrical machine. The webs can transmit force and/or a moment. In addition, the webs can produce an air flow during a rotary, movement of the rotor mount element 86, particularly if the webs are in the form of fan blades and/or are rotated about their longitudinal axis such that they act as fan blades.

The rotor 60 is aligned coaxially with respect to the projecting shaft end 98 of the crankshaft 46. Furthermore, the rotor 60 is in the form of an external rotor. The rotor is therefore arranged outside the stator 72. In comparison to an internal rotor, as is shown in FIGS. 3 and 4, a plurality of permanent magnets 90 can be arranged, preferably at equal distances from one another, over the circumference of the external rotor 60. An external rotor can therefore also have a higher magnetic flux density than an internal rotor. Since the power which can be emitted from a generator can be functionally traced back to a magnetic interaction with the permanent magnets in a rotor, an external rotor can in consequence also have a higher rating. In other words, the external rotor generator can advantageously have a higher power density than an internal rotor generator.

Furthermore, the rotor mount element 86 has an area 100 which opens coaxially and conically outward, and/or an area which is essentially at right angles to the rotation axis of the rotor 60, such that the rotor 60 and the rotor mount element 86 are preferably designed to grip around the stator 72. However, the rotor 60 or the rotor mount element 86 does not have its own shaft. The rotor 60 or the rotor mount element 86 therefore has no shaft. Since the rotor mount element 86 is preferably attached to the crankshaft 46 in a rotationally fixed manner, the rotor has no shaft outside the area of the attachment and/or of the crankshaft 46 in the radial area from 0 to 5 mm around the rotation axis of the rotor 60.

In addition, the rotor 60 has permanent magnets 88 which are oriented inward. For this purpose, the permanent magnets 88 can be integrated in the rotor 60 such that the inner surface of the rotor 60 is an essentially cylindrical envelope surface and, in particular in places, is formed by the permanent magnets 88.

The stator 72 or the stator housing 70 is connected in a fixed position to the engine housing 52. For this purpose, the stator 72 or the stator housing 70 may in particular be attached to the engine housing 52 by means of dowel pins and/or screw connections. The stator 72 has a plurality of stator coils 90, in particular sixteen stator coils 90, which are oriented radially outward, distributed over the circumference of the stator.

Furthermore, the stator has cooling elements, preferably generator cooling lines 78. These are arranged between the rotation axis of the rotor 60 and the stator coils 90. Furthermore, the generator cooling lines 78 are connected by means of pipe connecting lines 92 to the cooling, in particular to the cooling lines 76, of the reciprocating internal combustion engine 42.

The voltage which is induced in the stator coils 90 during the operation of the communal heating and power station can be transmitted to further electrical components by means of electrical connecting lines 94.

In order to protect the generator against external emissions, in particular against the ingress of dust or liquids, and/or in order to protect the rotor, which rotates during operation of the communal heating and power station, against accidental contact with human body members, the communal heating and power station may have a cover 102. The cover 102 surrounds the electrical generator 44 and ends at the reciprocating internal combustion engine housing 52.

1. A communal heating and power station unit having a reciprocating internal combustion engine and having an electrical generator, which are coupled to one another by means of a shaft which transmits power, the generator having a stator and a rotor, wherein the rotor is borne in a floating manner and wherein a reciprocating internal combustion engine housing also forms the stator housing, or the stator housing is flange-connected to the reciprocating internal combustion engine housing.

2. A use of a reciprocating internal combustion engine and of an electrical generator, which are coupled to one another by means of a shaft which transmits power, with the generator having a stator and a rotor, and with the rotor being borne in a floating manner, and with a reciprocating internal combustion engine housing also forming the stator housing, or the stator housing being flange-connected to the reciprocating internal combustion engine housing, as a communal heating and power station unit.

3. The unit or use as claimed in one of the preceding claims, wherein the generator is a synchronous machine, in particular with a permanent-magnet external rotor or internal rotor.

4. The unit or use as claimed in one of the preceding claims, wherein flange elements of the stator are oriented radially outward.

5. The unit or use as claimed in one of the preceding claims, wherein the stator is positioned with respect to the reciprocating internal combustion engine housing by means of dowel pins.

6. The unit or use as claimed in one of the preceding claims, wherein the wall of a first end face of the reciprocating internal combustion engine housing also forms an end wall of the stator.

7. The unit or use as claimed in one of the preceding claims, wherein the rotor is attached, preferably in a rotationally fixed manner, to a first, floating shaft end, which projects outward from the first end face.

8. The unit or use as claimed in one of the preceding claims, wherein the rotor has no shaft.

9. The unit or use as claimed in one of the preceding claims, wherein the shaft forms both the crankshaft of the reciprocating internal combustion engine and the shaft of the generator and/or rotor.

10. The unit or use as claimed in one of the preceding claims, wherein the rotor is borne on one side or in a floating manner by a bearing of the crankshaft of the reciprocating internal combustion engine, in which case the bearing may have a plurality of bearing points.

11. The unit or use as claimed in one of the preceding claims, wherein the crankshaft bearing is also the only bearing for the rotor.

12. The unit or use as claimed in one of the preceding claims, wherein a cooling circuit cools the reciprocating internal combustion engine and the stator at the same time, with water, oil or air preferably flowing through the cooling circuit.

13. The unit or use as claimed in one of the preceding claims, wherein at least one cooling line of the cooling is arranged on the radially outer circumference of the stator.

14. The unit or use as claimed in one of the preceding claims, wherein the rotor is cylindrical, and wherein the rotor is short, in particular with a maximum axial length of 4 cm to 6 cm, in particular 5 cm, and/or wherein the ratio of the maximum radial diameter to the maximum axial length of the rotor is greater than 4, in particular in a range from 4 to 10, preferably in a range from 5 to 7.

15. The unit or use as claimed in one of the preceding claims, wherein the rotor is separated by a narrow (air) gap, in particular of a maximum of 2 cm, preferably of a maximum of 5 mm, from the first end face of the reciprocating internal combustion engine housing, such that the (bending or tilting) moment caused by the rotor on the first bearing is as small as possible.

16. The unit or use as claimed in one of the preceding claims, wherein the generator is brushless.

17. The unit or use as claimed in one of the preceding claims, wherein the generator can also be operated as a motor, and wherein, in the motor mode, the generator is used to start the reciprocating internal combustion engine.

18. The unit or use as claimed in one of the preceding claims, wherein the reciprocating internal combustion engine and/or the generator has no separate inertia element, in particular no flywheel, or wherein no separate inertia element, in particular no flywheel, is attached to the shaft in the generator-side area leading away from the reciprocating internal combustion engine, and/or wherein an inertia element, in particular a separate inertia element and preferably a flywheel, is attached to the shaft in the area which is remote from the generator side and leads away from the reciprocating internal combustion engine.

19. The unit or use as claimed in one of the preceding claims, wherein the rotor is an inertia element of the reciprocating internal combustion engine.

20. The unit or use as claimed in one of the preceding claims, wherein a bearing of the crankshaft is also the bearing of an inertia element, in particular of a flywheel.

21. The unit or use as claimed in one of the preceding claims, wherein, in particular, sixteen electromagnetic coils are arranged distributed uniformly over the circumference of the stator.

22. The use as claimed in one of the preceding claims, wherein the cooling is coupled to a heat pump which transmits the heat power from the reciprocating internal combustion engine and from the generator to a thermodynamic system.
